(19) United States
(12) Patent Application Publication
(10) Pub. No.: US 2005/0111226 A1
(43) Pub. Date: May 26, 2005

(54) Electric lamp with recessed lens

(76) Inventors: Jeffrey P. Buschmann, Lexington, KY (US); Kevin R. Davies, Lexington, KY (US)

Correspondence Address: William E. Meyer;OSRAM SYLVANIA Inc., 100 Endicott Street, Danvers, MA, 01923, US

(21) Appl. No.: 10/803,347

(22) Filed: Mar. 18, 2004

Related U.S. Application Data
(60) Provisional application No. 60/456,823, filed on Mar. 21, 2003.

(51) Int. Cl. F21V 7/00

(52) U.S. Cl. 362/296

(57) ABSTRACT

The lens of a reflector type lamp may be recessed into the body of the reflector housing by molding the reflector interior with a ledged or similar support for the lens. The lens may then be hidden in the reflector housing. Light emitted from the lamp is then directed to the field of view, while light emerging from the lens edge is shielded by an extended sidewall of the reflector. The resulting view of the lamp is a very even distribution of emitted light.

The Applicants hereby claim the benefit of their provisional application Ser. No. 60/456,823 filed Mar. 21, 2003 titled ELONGATED ELECTRIC LAMP WITH RECESSED LENS.

### BACKGROUND OF THE INVENTION

1. Field of the Invention

The invention relates to electric lamps and particularly to reflector type electric lamp. More particularly the invention is concerned with a reflector lamp with an enclosed lens.

2. Description of the Related Art Including Information Disclosed Under 37 CFR 1.97 and 1.98

Reflector lamps are commonly made with a lens attached to the exterior rim of the glass reflector. These lamps are typically seen as flood lamps used for outdoor applications, but can be used for indoor applications also. In these lamps lens edge is then exposed from the side, and light may leak to the side of the lamp.

### BRIEF SUMMARY OF THE INVENTION

A reflector type electric lamp may be made with a sealed electric lamp capsule having two or more electric in-leads. A support in the reflector holds the lamp capsule. The reflector has an interior wall defining a cavity of rotation, a first edge defining a base opening and a second edge defining a face opening. The interior wall includes one or more projections offset from the face opening that extend into the defined cavity. The reflector encloses the entire lamp capsule. A lens is located entirely in the defined cavity, and spans a cross section of the cavity adjacent the one or more projections. The lens is sealed along a lens edge to the interior surface of the reflector, thereby closing the face end of the reflector. A threaded base provides electrical connection for the two or more electric leads and mechanical support for the support. The threaded base then closes off the base opening.

### BRIEF DESCRIPTION OF THE SEVERAL VIEWS OF THE DRAWINGS

FIG. 1 shows a cross sectional view of reflector lamp with a recessed lens.

FIG. 2 shows a cross sectional view of reflector lamp with a recessed lens, the lamp capsule being supported by a frame.

FIG. 3 shows a cross sectional view of reflector lamp with a recessed lens, the lamp capsule being supported by a rigid tubes.

### DETAILED DESCRIPTION OF THE INVENTION

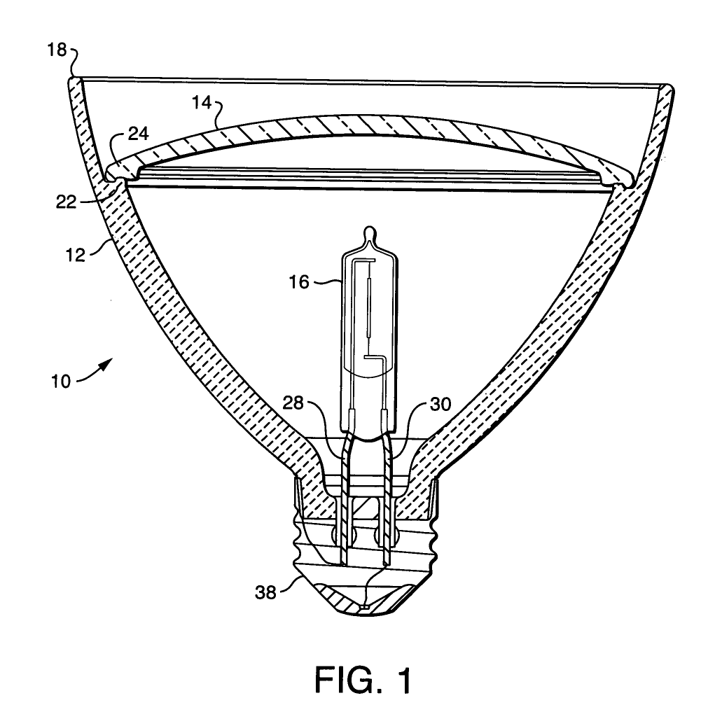

FIG. 1 shows a cross sectional view of reflector lamp with a recessed lens. The lamp 10 comprises a reflector 12, a lens 14 and a lamp capsule 16.

The reflector 12 has a base end with one or more openings for electrical leads and a forward most lip edge 18 defining a face opening. The reflector 12 includes an internal wall 20 with one or more internal projections 22 that is or are substantially recessed from the lip edge 18. The preferred reflector 12 has an interior wall 20 defining a cavity of rotation, so the projection 22 may be a circular ledged.

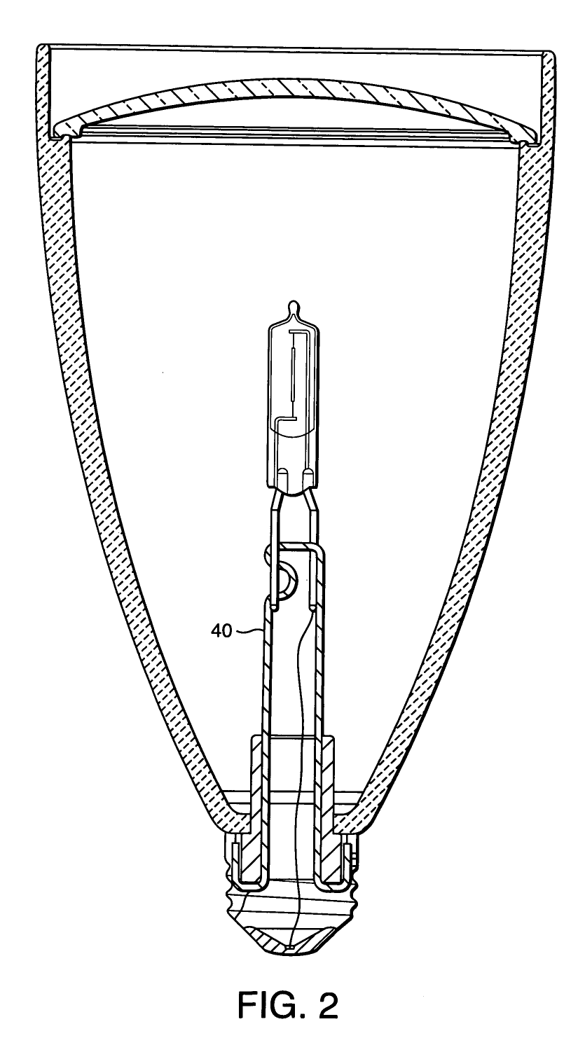

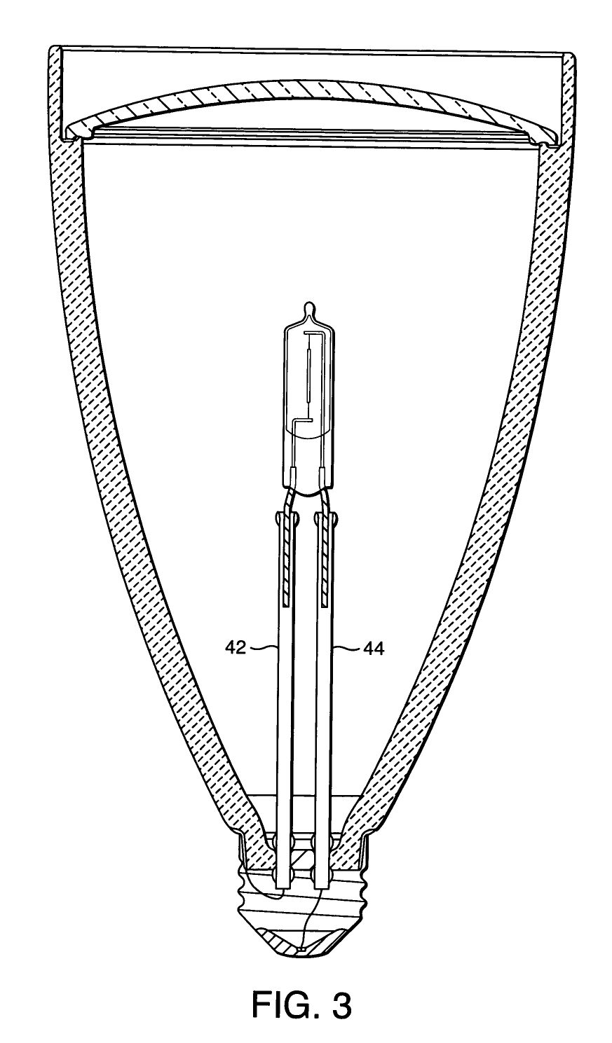

The lens 14 includes a circumferential edge 24 shaped to mate with the interior wall 20 of the reflector 12 along the projection 22. In the preferred embodiment the lens 14 is circular so as to mate with the preferred circular ledge. The lens 14 is preferably glued to the support projections 22, but flame sealing and other bonding methods are possible. The lens may include any of the known light distributing features. The projection 22 supports the lens 14 along the exterior edge 24 of the lens so the lens 14 is then located entirely in the reflector 12, so that no light may leak to the side. The lens 14 spans a cross section of the reflector cavity adjacent the one or more projections 22 and is sealed along to the interior wall 20. The forward face opening of the reflector 12 is then seal by the enclosed lens 14. Enclosed by the reflector 12 and lens 14 is a lamp capsule 16. The lamp capsule 16 has two or more electric in-leads 28, 30. The lamp capsule 26 is held by a support. The support may consist of the leads 28, 30. The capsule may be supported by a frame 40 extended from the reflector 12 or the base 38. FIG. 2 shows a cross sectional view of reflector lamp with a recessed lens, the lamp capsule being supported by a frame 40. The lamp capsule may be supported by rigid tubes 42, 44 extended from the reflector or the base 38. FIG. 3 shows a cross sectional view of reflector lamp with a recessed lens, the lamp capsule being supported by a rigid tubes 42, 44 crimped to the reflector 12. Similar support structures may be used. The preferred lamp capsule 16 is a tungsten halogen lamp supported on a metal frame. The frame providing electrical connection through the reflector base end openings to a threaded base to be supported in a standard screw type lamp socket.

A threaded base 38 provides electrical connections for the two or more electric leads 28, 30 and may additionally provide mechanical support for the support frame. The base 38 then closes off the base end of the reflector 12, and provides mechanical attachment for the lamp 10.

The forward lip edge 18 of the reflector 12 then shields the edge view of the lens and thereby guides all light emitted by the lens. This results in a more esthetic projection of the light. The reflector may be clear, or opaque. The preferred reflector embodiment uses a two-ply glass with a white interior and a colored exterior. Some of the light is then reflected out through the lens, and some light passes through the reflector sidewall to provide a diffused, colored, or glowing image. The preferred colors are blue, red and amber. Others may be used. The lens may include typical lens features to form a wide or narrow beam or similar pattern. The lens may be clear or frosted. The preferred lens is a circular section formed as an arched plate. The edge of the plate is bonded to a step formed on the interior wall of the reflector that is offset form the end lip of the reflector sufficient that that whole of the lens is recessed from the end lip of the reflector. The preferred recess amount is substantial. The reflector may be molded like an open-ended bottle. The preferred reflector includes an end wall with formed through passages that support the frame holding the lamp capsule. Alternatively an insert may be used to fill the base end opening of the reflector and support the lamp capsule frame.

While there have been shown and described what are at present considered to be the preferred embodiments of the invention, it will be apparent to those skilled in the art that various changes and modifications can be made herein without departing from the scope of the invention defined by the appended claims.

1. An electric lamp comprising:
a sealed electric lamp capsule having two or more electric in-leads;
a support holding the lamp capsule;
a reflector having an interior wall defining a cavity of rotation, the reflector having a first edge defining a base opening and a second edge defining a face opening, the interior wall including one or more projections offset from the face opening and extending into the defined cavity; the reflector enclosing the lamp capsule;
a lens located entirely in the defined cavity, and spanning a cross section of the cavity adjacent the one or more projections and sealed along the lens to the interior surface; and
a threaded base providing electrical connection for the two or more electric leads and mechanical support for the support frame.

2. The electric lamp in claim 1, wherein the projection comprises a step formed on the interior wall of the reflector.

3. The electric lamp in claim 1, wherein the support includes two or more, and substantially mechanically attached to and extending from the base, having electrical connections extending through the tubes.

4. The electric lamp in claim 1, wherein the support includes two or more substantially rigid tubes mechanically attached to and extending trough the reflector, having electrical connections extending through the tubes.

5. The electric lamp in claim 1, wherein the base includes a rigid non-conducting body mechanically coupled to the reflector adjacent the base opening; the non-conducting body being formed with two or more axially extending crevices enclosing to brace at least end portions of the support frame.

6. The electric lamp in claim 3, wherein the base includes a rigid non-conducting body mechanically coupled to the reflector adjacent the base opening; the non-conducting body being formed with two or more axially extending crevices enclosing to brace at least portions of the rigid tubes.

7. The electric lamp in claim 4, wherein the non-conducting body is bonded to the reflector by an intermediate material.

8. An electric lamp comprising:
a sealed electric lamp capsule having two or more electric in-leads;
a support frame holding the lamp capsule;
a reflector having an interior wall defining a cavity or rotation, the reflector having a first edge defining a base opening and a second edge defining a face opening, the interior wall including one or more projections offset from the face opening extending into the defined cavity; the reflector enclosing the lamp capsule;
a lens with an exterior most face substantially located in the defined cavity, and spanning a cross section of the cavity adjacent the one or more projections and sealed along the lens to the interior surface; the planar face located to span the face opening; and
a threaded base providing electrical connection for the two or more electric leads and mechanical support for the support frame; the base including a rigid non-conducting body mechanically coupled to the reflector adjacent the base opening; the non-conducting body being formed with two or more axially extending crevices enclosing to brace at least end portions of the support frame.

9. The electric lamp in claim 8, wherein the projection comprises a step formed on the interior wall of the reflector.

10. The electric lamp in claim 8, wherein the support frame includes two or more, and substantially rigid tubes mechanically attached to and extending from the base, having electrical connections extending through the tubes.

11. The electric lamp in claim 8, wherein the rigid non-conducting body is formed with two or more axially extending crevices enclosing to brace at least portions of the rigid tubes.

12. The electric lamp in claim 8, wherein the non-conducting body is bonded to the reflector by an intermediate material.

13. The electric lamp in claim 1, wherein the reflector has an end wall separating the reflector surface from the base, and the end wall is formed with two through passages supporting, and the support frame extends through the formed passages and is fixed to the reflector at each end of the formed passages.

14. The electric lamp in claim 14, wherein the support frame includes tubular elements extending through the formed passages, each tubular element being crimped on either side of end wall adjacent the end wall to lock the tubular piece to the end wall.

15. The electric lamp in claim 14, wherein a quantity of glue is positioned between the reflector and the tubular elements to glue to the tubular elements to the reflector.

16. The electric lamp in claim 14, wherein tubular elements include flared ends on one side of the end wall, and a crimp is formed on tubular element adjacent the other side of the end wall to locked the tubular element to the end wall, and lead rods are extended in the tubular elements to be braced along a length of the tubular element, and coupled to the tubular element at least one point for example by crimping the tubular element to the enclosed lead rod.
